(19) United States
(12) Patent Application Publication
(10) Pub. No.: US 2006/0084736 A1
(43) Pub. Date: Apr. 20, 2006

(54) Thermosetting one-solution type composition for protective film of color filter and color filter using the same

(76) Inventors: Won Bum Jang, Seoul (KR); Shin Utsunomiya, Seoul (KR); Sun Yul Lee, Seoul (KR)

Correspondence Address: CLARK & ELBING LLP, 101 FEDERAL STREET, BOSTON, MA, 02110, US

(21) Appl. No.: 11/192,901

(22) Filed: Jul. 29, 2005

(30) Foreign Application Priority Data
Oct. 15, 2004 (KR) 2004-82602

(51) Int. Cl. C08K 5/07

(52) U.S. Cl. 524/356; 524/556; 524/522; 524/366; 524/386

(57) ABSTRACT

Disclosed herein is a thermosetting one-solution type composition for a protective film of a color filter. Specifically, a thermosetting one-solution type composition for a protective film of a color filter, which includes a self-curing copolymer obtained by copolymerizing one or two kinds of (meth)acrylate having an epoxy ring structure at a side chain thereof with (meth)acrylate having a terminal hydroxide group, and an organic solvent, is provided, and also, a color filter including the protective film manufactured using the above composition and a liquid crystal display including the color filter are provided. The thermosetting one-solution type composition for a protective film of a color filter of the current invention has good adhesive strength, transparency, film strength, heat resistance, acid resistance, and alkali resistance, and as well, can be stored for a long time.

### CROSS-REFERENCE TO RELATED APPLICATIONS

This application claims priority to Korean Patent Application No. 2004-82602 filed on Oct. 15, 2004, which is incorporated herein in its entirety by reference.

### BACKGROUND OF THE INVENTION

1. Field of the Invention

The present invention relates, generally, to a thermosetting one-solution type composition for a protective film of a color filter, and more particularly, to a thermosetting one-solution type composition for a protective film of a color filter, which includes a self-curing copolymer obtained by copolymerizing one or two kinds of (meth)acrylate having an epoxy ring structure at a side chain thereof with (meth)acrylate having a terminal hydroxide group, and an organic solvent, and to a color filter including the protective film manufactured using the same and a liquid crystal display including the color filter.

2. Description of the Related Art

In order to flatten and protect the surface of a color filter for a liquid crystal display, a protective film has typically been attached thereto. Such a surface protective film should exhibit optical transparency and sufficient film strength, and also, have sufficient heat resistance to undergo a process of forming a transparent conductive film on the protective film.

Further, a protective film useful for a recently developed homeotropic alignment type liquid crystal display should have acid resistance to endure etching, and also, alkali resistance to undergo a process of stripping a resist, in addition to transparency, film strength, and heat resistance.

A conventional material for a protective film of a color filter and a process of forming the protective film are well known. That is, Japanese Patent Laid-open Publication No. Hei. 1-134306 discloses the use of glycidylmethacrylate as a main component, and Japanese Patent Laid-open Publication No. Sho. 62-163016 discloses the use of polyimide as a main component. Also, Japanese Patent Laid-open Publication No. Sho. 63-131103 discloses a mixture of a melamine resin and an epoxy resin serving as a main component.

In addition, to prepare a composition for a protective film of a color filter having adhesive strength, heat resistance, chemical resistance and water resistance using an epoxy resin, highly reliable techniques are known. That is, Japanese Patent Laid-open Publication No. Hei. 08-050289 discloses a curing resin composition obtained by adding a phenol type curing agent to a glycidylmethacrylate polymer. Also, Japanese Patent Laid-open Publication No. Hei. 08-201617 discloses a resin composition for a transparent film composed of an epoxy resin, a curing agent and an organic solvent, in which the curing agent, resulting from the reaction between a styrene maleic anhydride copolymer and amine, is used.

Generally, an epoxy resin is known to rapidly react with a curing agent, and thus, is frequently used in a two-component system mixing a main agent with a curing agent, and is difficult to use in a one-component system. The two-component epoxy resin system is difficult to handle, and is unsuitable for use in industrial production.

However, the above-mentioned conventional techniques do not form a one-component epoxy resin system while realizing all of transparency, film strength, heat resistance, acid resistance and alkali resistance. In this regard, although Japanese Patent Laid-open Publication No. 2001-091732 discloses a technique for manifesting storage stability by protecting a polyfunctional carboxylic acid compound with vinyl ether, the protection process is complicated, and hence, negatively affects the final cost. Further, since the vinyl ether used is harmful to human beings, whether vinyl ether may be industrially applied is doubtful.

### SUMMARY OF THE INVENTION

Accordingly, the present invention has been made keeping in mind the above problems occurring in the related art, and an object of the present invention is to provide a thermosetting one-solution type composition for a protective film of a color filter, which exhibits good adhesive strength, transparency, film strength, heat resistance, acid resistance and alkali resistance, and may also be stored for a long time.

Another object of the present invention is to provide a color filter, which includes a protective film, having excellent flatness, coherence and film strength, manufactured using the above composition.

A further object of the present invention is to provide a liquid crystal display including the color filter.

In order to accomplish the above objects, according to a first embodiment of the present invention, a thermosetting one-solution type composition for a protective film of a color filter is provided, which comprises a self-curing copolymer formed by copolymerizing one or two kinds of (meth)acrylate having an epoxy ring structure at a side chain thereof with (meth)acrylate having a terminal hydroxide group, and an organic solvent.

According to a second embodiment of the present invention, a color filter is provided, which comprises the protective film manufactured using the above composition.

According to a third embodiment of the present invention, a liquid crystal display that comprises the above color filter is provided.

### DESCRIPTION OF THE PREFERRED EMBODIMENTS

Hereinafter, a detailed description will be given of the present invention.

In the present invention, a thermosetting one-solution type composition for a protective film of a color filter includes (i) a self-curing copolymer, which includes at least one selected from among constituent units represented by Formulas 1 and 2, below, and a constituent unit represented by Formula 3, below; and (ii) an organic solvent:

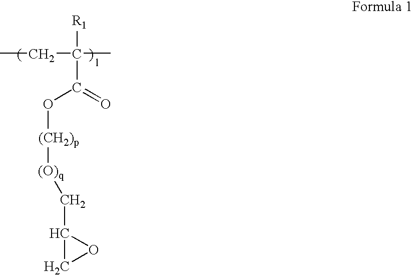

Wherein each R₁ is independently a hydrogen atom or a methyl group, l is 20-85 mol %, p is an integer of 0 or from 2 to 9, and q is 0 when p is 0, or 1 when p is 2 to 9;

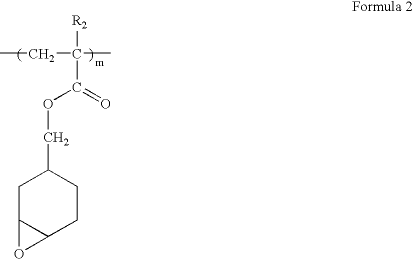

Wherein each R₂ is independently a hydrogen atom or a methyl group, and m is 20-85 mol %; and

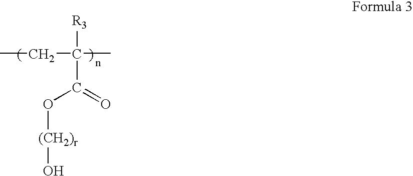

Wherein each R₃ is independently a hydrogen atom or a methyl group, n is 5-45 mol %, and r is an integer from 2 to 9.

The self-curing copolymer constituting the composition for a protective film of the present invention has thermosetting properties through a thermal crosslink reaction between the at least one selected from among constituent units represented by Formulas 1 and 2 and the constituent unit represented by Formula 3.

Among the constituent units of the self-curing copolymer, the sum of the proportion of the constituent unit represented by Formula 1 (wherein l is 20-85 mol %) and the proportion of the constituent unit represented by Formula 2 (wherein m is 20-85 mol %), that is, l+m, is preferably in the range of 20 to 85 mol %. If the proportion of l+m is too low or too high, the thermosetting one-solution type composition for a protective film of a color filter of the present invention does not exhibit thermosetting properties, and also, has decreased heat resistance and chemical resistance including acid resistance and alkali resistance.

The self-curing copolymer may be optionally prepared in the form of a random copolymer, a crosslinked copolymer, a block copolymer, or a graft copolymer.

In the thermosetting one-solution type composition for a protective film of a color filter of the present invention, the self-curing copolymer further includes a constituent unit represented by Formula 4, below:

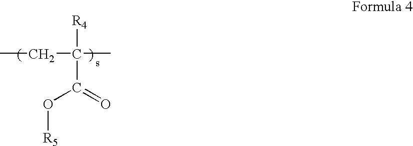

Wherein each R₄ is independently a hydrogen atom or a methyl group, s is 10-30 mol %, and each R₅ is independently any one selected from among compounds represented by Formula 5, below:

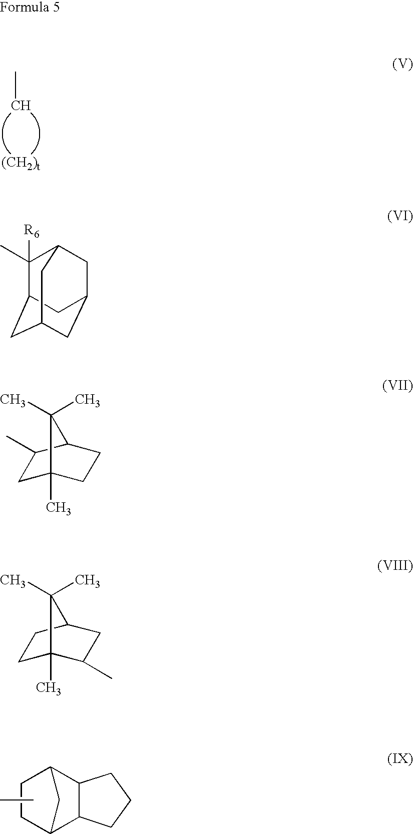

Wherein t is an integer from 4 to 12, and R₆ is a hydrogen atom or a methyl group.

In this way, the self-curing copolymer further includes the constituent unit represented by Formula 4, thereby having increased transparency and solubility in an organic solvent.

The proportion s of the constituent unit represented by Formula 4 preferably falls in the range from 10 to 30 mol %, without reduction to adhesive strength, transparency, film strength, heat resistance, acid resistance, alkali resistance and long storability.

Also, the self-curing copolymer may further include a copolymerizable component in a range that does not worsen the physical properties required for the composition for a protective film of the present invention, in addition to the at least one selected from among constituent units represented by Formulas 1 and 2, the constituent unit represented by Formula 3, and the constituent unit represented by Formula 4.

The copolymerizable component, which is further included in the self-curing copolymer, is exemplified by unsaturated organic acids such as (meth)acrylic acid or maleic acid and anhydrides thereof, (meth)acrylates such as methyl(meth)acrylate, ethyl(meth)acrylate, propyl(meth)acrylate, isopropyl(meth)acrylate, butyl(meth)acrylate, benzyl(meth)acrylate or hydroxypropyl(meth)acrylate, acrylamides such as N-methylacrylamide, N-ethylacrylamide, N-isopropylacrylamide, N-methylolacrylamide, N-methylmethacrylamide, N-ethylmethacrylamide, N-isopropylmethacrylamide, N-methylolmethacrylamide, N,N-dimethylacrylamide, N,N-diethylacrylamide, N,N-dimethylmethacrylamide or N,N-diethylmethacrylamide, styrenes such as styrene, α-methylstyrene or hydroxystyrene, N-vinylpyrrolidone, N-vinylformamide, N-vinylamide, and N-vinylimidazole.

The copolymerizable component is preferably used in an amount less than 15 mol % so as not to decrease the adhesive strength of the self-curing copolymer constituting the composition for a protective film of the present invention, or the physical properties of the protective film manufactured using the above composition.

The self-curing copolymer has a weight average molecular weight ranging from 3,000 to 1,000,000, but is not limited thereto. Too low a molecular weight results in insufficient curability, whereas too high a molecular weight results in decreased solvent solubility or applicability.

The organic solvent, serving as the essential component of the thermosetting one-solution type composition for a protective film of a color filter of the present invention, is preferably any material able to dissolve the above copolymer, although it is not particularly limited in the present invention. The usable organic solvent includes at least one selected from the group consisting of ethyleneglycols such as ethyleneglycol or diethyleneglycol, glycolethers such as ethyleneglycolmonomethylether, diethyleneglycolmonomethylether, ethyleneglycoldiethylether or diethyleneglycoldimethylether, glycoletheracetates such as ethyleneglycolmonoethyletheracetate, diethyleneglycolmonoethyletheracetate or diethyleneglycolmonobutyletheracetate, propyleneglycols such as propyleneglycol, propyleneglycolethers such as propyleneglycolmonomethylether, propyleneglycolmonoethylether, propyleneglycolmonopropylether, propyleneglycolmonobutylether, propyleneglycoldimethylether, dipropyleneglycoldimethylether, propyleneglycoldiethylether or dipropyleneglycoldiethylether, propyleneglycoletheracetates such as propyleneglycolmonomethyletheracetate or dipropyleneglycolmonoethyletheracetate, amides such as N-methylpyrrolidone, dimethylformamide or dimethylacetamide, ketones such as methylethylketone (MEK), methylisobutylketone (MIBK) or cyclohexanone, petroleum such as toluene, xylene or solvent naphtha, esters such as ethylacetate, butylacetate or ethyloleate, and combinations thereof.

Meanwhile, the self-curing copolymer may be synthesized using any conventional method without being particularly limited. Preferably, the self-curing copolymer is synthesized using a radical polymerization initiator in the presence of an organic solvent like the organic solvent included in the thermosetting one-solution type composition for a protective film of a color filter of the present invention.

That is, although the organic solvent used for the preparation of the self-curing copolymer is not particularly limited, an organic solvent like the organic solvent used as the essential component of the thermosetting one-solution type composition for a protective film of a color filter of the present invention as mentioned above is preferably used. As such, it is preferable that the amount of organic solvent used for the polymerization be controlled so that the self-curing copolymer has a concentration from 5 to 50 wt % in the solution of the organic solvent and the self-curing copolymer. More preferably, the concentration is 10 to 30 wt %. If the concentration of the self-curing copolymer in the above solution is less than 5 wt %, unreacted monomer remains due to a slow polymerization rate and thus may cause problems. On the other hand, if the concentration of the self-curing copolymer exceeds 50 wt %, the self-curing copolymer is difficult to handle because it is too viscous, and the reaction rate becomes difficult to control.

As the polymerization initiator used for polymerization of the self-curing copolymer, any known initiator, such as a thermal polymerization initiator, a light polymerization initiator, an oxidation-reduction initiator, etc., may be used. In particular, a peroxide or azo type radical polymerization initiator is preferably used in view of easy handling, and easy control of the reaction rate and the molecular weight.

The peroxide type polymerization initiator usable in the present invention includes, for example, methylethylketoneperoxide, cyclohexanoneperoxide, methylcyclohexanoneperoxide, acetylacetoneperoxide, 1,1-bis (tert-butylperoxy)3,3,5-trimethylcyclohexane, 1,1-bis(tert-butylperoxy) cyclohexane, 1,1-bis(tert-hexylperoxy)3,3,5-trimethylcyclohexane, 1,1-bis(tert-hexylperoxy)cyclohexane, 1,1-bis(tert-butylperoxy)cyclododecane, isobutylperoxide, lauroylperoxide, succinic acid peroxide, 3,5,5-trimethylhexanoylperoxide, benzoylperoxide octanoylperoxide, stearoylperoxide, diisopropylperoxydicarbonate, dinormalpropylperoxydicarbonate, di-2-ethylhexylperoxydicarbonate, di-2-ethoxyethylperoxydicarbonate, di-2-methoxybutylperoxydicarbonate, bis-(4-tert-butylcyclohexyl)peroxydicarbonate, (α,α-bis-neodecanoylperoxy)diisopropylbenzene, peroxyneodecanoic acid cumylester, peroxyneodecanoic acid octylester, peroxyneodecanoic acid hexylester, peroxyneodecanoic acid-tert-butylester, peroxypivalic acid-tert-hexylester, peroxypivalic acid-tert-butylester, 2,5-dimethyl- 2,5-bis (2-ethylhexanoylperoxy)hexane, 1,1,3,3-tetramethylbutylperoxy-2-ethylhexanoate, peroxy-2-ethylhexanoic acid-tert-hexylester, peroxy-2-ethylhexanoic acid-tert-butylester, peroxy-2-ethylhexanoic acid-tert-butylester, peroxy-3-methylpropionic acid-tert-butylester, peroxylauric acid-tert-butylester, tert-butylperoxy-3,5,5-trimethylhexanoate, tert-hexylperoxyisopropylmonocarbonate, tert-butylperoxyisopropylcarbonate, 2,5-dimethyl-2,5-bis(benzoylperoxy)hexane, peracetic acid-tert-butylester, perbenzoic acid-tert-hexylester, perbenzoic acid-tert-butylester, etc. In addition, a reducing agent may be added to the above-mentioned peroxide type polymerization initiator, which then may be used as an oxidation-reduction initiator.

The azo type polymerization initiator usable in the present invention includes, for example, 1,1-azobis(cyclohexane-1-carbonitrile), 2,2′-azobis(2-methyl-butyronitrile), 2,2′-azobisbutyronitrile, 2,2′-azobis(2,4-dimethyl-valeronitrile), 2,2′-azobis(2,4-dimethyl-4-methoxyvaleronitrile), 2,2′-azobis(2-amizino-propane)hydrochloride, 2,2′-azobis[2-(5-methyl-2-imidazolin-2-yl)propane]hydrochloride, 2,2′-azobis[2-(2-imidazolin-2-yl)propane]hydrochloride, 2,2′-azobis[2-(5-methyl-2-imidazolin-2-yl)propane], 2,2′-azobis-2-methyl-N-(1,1-bis(2-hydroxymethyl)-2-hydroxyethyl)propionamide, 2,2′-azobis[2-methyl-N-(2-hydroxyethyl)propionamide], 2,2′-azobis(2-methyl-propionamide)dihydrate, 4,4′-azobis(4-cyano-valeric acid), 2,2′-azobis(2-hydroxymethylpropionitrile), 2,2′-azobis(2-methylpropionic acid)dimethylester(dimethyl-2,2′-azobis(2-methylpropionate)) (V-601, Wako Pure Chemicals Industries, Ltd., Japan), cyano-2-propylazoformamide, etc.

Further, a known molecular weight controller, such as a chain transfer agent, a chain terminator, a polymerization accelerator, etc., may be added to achieve the preferred molecular weight range upon polymerization of the self-curing copolymer, in addition to the peroxide type polymerization initiator or azo type polymerization initiator. For example, mercaptopropionic acid, mercaptopropionic acid ester, thioglycol, thioglycerine, dodecylmercaptane, α-methylstyrenedimer, etc., may be used.

After the polymerization, a solvent other than the organic solvent used for the polymerization may be used to aid the solubility of the constituent components, and control leveling property and drying speed.

Moreover, the synthesized copolymer may be extracted into a solid for purification, storage, and solvent change, which then may be used to manufacture the thermosetting one-solution type composition for a protective film of a color filter. Although an extraction process is not limited, spray drying, film drying, adding in droplets to a poor solvent, or reprecipitation, may be used.

To increase etching resistance and alkali resistance and control fluidibility of the thermosetting one-solution type composition for a protective film of a color filter of the present invention, a polymer other than the self-curing copolymer may be further included. Although the further included polymer is not particularly limited, it is exemplified by epoxy resins such as bisphenol-A epoxy, bisphenol-F epoxy, phenol novolac type epoxy, cresol novolac type epoxy or substituted epoxy, poly(meth)acrylate, nylon, polyester, polyimide, and a silicon polymer. As such, the above polymer is preferably used in an amount of 50 parts by weight or less based on 100 parts by weight of the self-curing copolymer.

Further, to the thermosetting one-solution type composition for a protective film of a color filter of the present invention, an amine compound, a phosphor compound, a boron compound, an antimony compound, a carboxylic acid compound, or an organic sulfonic acid compound may be added as a thermosetting reaction catalyst. The thermosetting reaction catalyst is preferably used in an amount of 10 parts by weight or less based on 100 parts by weight of the self-curing copolymer, to ensure storage stability.

Also, the thermosetting one-solution type composition for a protective film of a color filter of the present invention may further include a conventionally known component, for example, an antioxidant, an infrared stabilizer, a plasticizer, a leveling agent, a coupling agent, a filler, etc., if necessary.

In addition, to manufacture the protective film of a color filter, the thermosetting one-solution type composition for a protective film of a color filter of the present invention is applied on a substrate, using screen printing, curtain coating, blade coating, spin coating, spray coating, dip coating, flow coating, roll coating, slit coating, etc. The dry thickness of a coating film ranges from 0.5 to 5.0 μm, and preferably from 0.7 to 2.5 μm. If the coating film is formed in a thickness less than 0.5 μm, which is too thin, sufficient flatness at an uneven surface cannot be obtained. Meanwhile, if the coating film is formed in a thickness exceeding 5.0 μm, which is too thick, transmittance is decreased, and as well, drying and curing require a long time, and productivity is reduced.

From the substrate on which the thermosetting one-solution type composition for a protective film of a color filter of the present invention is applied, the solvent is volatilized through drying-heat curing, and then, the applied composition is cured by a crosslink reaction to form a hard film. As such, the drying process and the heat curing process may be simultaneously or separately performed. However, since drastic heating may cause foam or cracks, it is preferable that the drying process and the heat curing process be separately conducted.

The device used for the drying process, which is not particularly limited, may be a hot air dryer, a far infrared dryer, a hot plate, etc. The drying temperature preferably ranges from 50 to 150° C., and also, the drying time is in the range from 1 to 10 min depending on the capacity of the dryer, wind speed, temperature, and film thickness.

The device used for the heat curing process, which is not particularly limited, may be a hot air oven, a far infrared oven, a hot plate, etc. The heat treatment temperature preferably ranges from 150 to 250° C. If the heat treatment temperature is lower than 150° C., the curing reaction insufficiently takes place. On the other hand, if the temperature exceeds 250° C., depolymerization or carbonization of a polymer compound occurs, thus deteriorating the performance of the obtained film.

In addition, the color filter including the protective film manufactured by the above-mentioned method may be applied to a liquid crystal display.

A better understanding of the present invention may be obtained in light of the following examples which are set forth to illustrate, but are not to be construed to limit the present invention.

### SYNTHETIC EXAMPLE 1

297 g of propyleneglycolmonomethyletheracetate were loaded into a 500 ml flask equipped with a reflux condenser and a stirrer, and then stirred, and the reaction temperature was increased to 80° C. Subsequently, the reaction temperature was maintained at 80° C., and a mixture comprising 56 g of 2-hydroxyethylacrylate, 78 g of methacrylic acid glycidyl and 6.8 g of dimethyl-2,2′-azobis(2-methylpropionate) (V-601, Wako Pure Chemicals Industries, Ltd., Japan) was added in droplets to the material in the flask for 1-1.5 hr while being stirred. After completion of the addition of droplets of the mixture, the reaction temperature was maintained at 80° C., and the reaction occurred for 4-5 hr while the solution in the flask was stirred, to obtain a transparent polymer solution A. This solution had a weight average molecular weight of 32,000 measured by GPC (gel permeation chromatography) using polystyrene as the standard.

### SYNTHETIC EXAMPLE 2

290 g of propyleneglycolmonomethyletheracetate were loaded into a 500 ml flask equipped with a reflux condenser and a stirrer, and then stirred, and the reaction temperature was increased to 80° C. Subsequently, the reaction temperature was maintained at 80° C., and a mixture comprising 14 g of 2-hydroxyethylmethacrylate, 34 g of methacrylic acid glycidyl, 78 g of dicyclopentanylmethacrylate (FA-513M, Hitachi Chemical Co. Ltd., Japan) and 6.8 g of dimethyl-2,2′-azobis(2-methylpropionate) (V-601, Wako Pure Chemical Industries, Ltd., Japan) was added in droplets to the material in the flask for 1-1.5 hr while being stirred. After completion of the addition of droplets of the mixture, the reaction temperature was maintained at 80° C., and the reaction occurred for 4-5 hr while the solution in the flask was stirred, to obtain a transparent polymer solution B. This solution had a weight average molecular weight of 32,000 measured by GPC using polystyrene as the standard.

### SYNTHETIC EXAMPLE 3

290 g of propyleneglycolmonomethyletheracetate were loaded into a 500 ml flask equipped with a reflux condenser and a stirrer, and then stirred, and the reaction temperature was increased to 80° C. Subsequently, the reaction temperature was maintained at 80° C., and a mixture comprising 28 g of 2-hydroxyethylmethacrylate, 18 g of methacrylic acid glycidyl, 78 g of dicyclopentanylmethacrylate (FA-513M, Hitachi Chemical Co. Ltd., Japan) and 6.8 g of dimethyl-2,2′-azobis(2-methylpropionate) (V-601, Wako Pure Chemical Industries, Ltd., Japan) was added in droplets to the material in the flask for 1-1.5 hr while being stirred. After completion of the addition of droplets of the mixture, the reaction temperature was maintained at 80° C., and the reaction occurred for 4-5 hr while the solution in the flask was stirred, to obtain a transparent polymer solution C. This solution had a weight average molecular weight of 32,000 measured by GPC using polystyrene as the standard.

### SYNTHETIC EXAMPLE 4

290 g of propyleneglycolmonomethyletheracetate were loaded into a 500 ml flask equipped with a reflux condenser and a stirrer, and then stirred, and the reaction temperature was increased to 80° C. Subsequently, the reaction temperature was maintained at 80° C., and a mixture comprising 28 g of 2-hydroxyethylmethacrylate, 18 g of methacrylic acid glycidyl, 60 g of styrene, and 6.8 g of dimethyl-2,2′-azobis(2-methylpropionate) (V-601, Wako Pure Chemical Industries, Ltd., Japan) was added in droplets to the material in the flask for 1-1.5 hr while being stirred. After completion of the addition of droplets of the mixture, the reaction temperature was maintained at 80° C., and the reaction occurred for 4-5 hr while the solution in the flask was stirred, to obtain a transparent polymer solution D. This solution had a weight average molecular weight of 21,000 measured by GPC using polystyrene as the standard.

### COMPARATIVE SYNTHETIC EXAMPLE 1

390.0 g of propyleneglycolmonomethyletheracetate were loaded into a 500 ml flask equipped with a reflux condenser and a stirrer, and then stirred, and the reaction temperature was increased to 80° C. Subsequently, the reaction temperature was maintained at 80° C., and a mixture comprising 79 g of methacrylic acid glycidyl, 30 g of dicyclopentanylmethacrylate (FA-513M, Hitachi Chemical Co. Ltd., Japan), 12 g of styrene, and 8.5 g of dimethyl-2,2′-azobis(2-methylpropionate) (V-601, Wako Pure Chemical Industries, Ltd., Japan) was added in droplets to the material in the flask for 1-1.5 hr while being stirred. After completion of the addition of droplets of the mixture, the reaction temperature was maintained at 80° C., and the reaction occurred for 3 hr while the solution in the flask was stirred, to obtain a transparent polymer solution E. This solution had a weight average molecular weight of 17,000 measured by GPC using polystyrene as the standard.

### PREPARATIVE EXAMPLE 1

40 g of the polymer solution A obtained in Synthetic Example 1 were mixed with 3.5 g of an epoxy resin (EP-154, JER), 1.4 g of a silane coupling agent (S-510, Chisso), 0.12 g of a surfactant (frorard FC-430, Suimitomo 3M) and 31 g of propyleneglycolmonomethyletheracetate, and then the reaction mixture was sufficiently stirred, dissolved and filtered, to obtain a desired thermosetting one-solution type composition for a protective film of a color filter F.

### PREPARATIVE EXAMPLE 2

A thermosetting one-solution type composition for a protective film of a color filter G was prepared in the same manner as in Preparative Example 1, with the exception that 40 g of the polymer solution B obtained in Synthetic Example 2 were used, instead of the polymer solution A.

### PREPARATIVE EXAMPLE 3

A thermosetting one-solution type composition for a protective film of a color filter H was prepared in the same manner as in Preparative Example 1, with the exception that 40 g of the polymer solution C obtained in Synthetic Example 3 were used, instead of the polymer solution A.

### PREPARATIVE EXAMPLE 4

A thermosetting one-solution type composition for a protective film of a color filter I was prepared in the same manner as in Preparative Example 1, with the exception that 40 g of the polymer solution D obtained in Synthetic Example 4 were used, instead of the polymer solution A.

### COMPARATIVE PREPARATIVE EXAMPLE 1

40 g of the polymer solution E obtained in Comparative Synthetic Example 1 were mixed with 3.5 g of an epoxy resin (EP-154, JER), 1.4 g of a silane coupling agent (S-510, Chisso), 3.1 g of trimellitic anhydride (Aldrich), 0.12 g of a surfactant (frorard FC-430, Suimitomo 3M) and 31 g of propyleneglycolmonomethyletheracetate, and then, the reaction mixture was sufficiently stirred, dissolved and filtered, to obtain a thermosetting one-solution type composition for a protective film of a color filter J.

### EXAMPLE 1

The thermosetting one-solution type composition for a protective film of a color filter F prepared in Preparative Example 1 was applied on each of a glass substrate (No. 1737, thickness: 0.7 mm, Corning Co. Ltd.) and a dummy color filter having an RGB pattern using a spin coater, dried at 80° C. for 3 min using a dryer, and then cured at 220° C. for 50 min, to obtain a 1.5 μm thick transparent protective film and a color filter.

### EXAMPLE 2

A 1.5 μm thick transparent protective film and a color filter were obtained in the same manner as in Example 1, with the exception that the thermosetting one-solution type composition for a protective film of a color filter G prepared in Preparative Example 2 was used, instead of the thermosetting one-solution type composition for a protective film of a color filter F.

### EXAMPLE 3

A 1.5 μm thick transparent protective film and a color filter were obtained in the same manner as in Example 1, with the exception that the thermosetting one-solution type composition for a protective film of a color filter H prepared in Preparative Example 3 was used, instead of the thermosetting one-solution type composition for a protective film of a color filter F.

### EXAMPLE 4

A 1.5 μm thick transparent protective film and a color filter were obtained in the same manner as in Example 1, with the exception that the thermosetting one-solution type composition for a protective film of a color filter I prepared in Preparative Example 4 was used, instead of the thermosetting one-solution type composition for a protective film of a color filter F.

### COMPARATIVE EXAMPLE 1

A 1.5 μm thick transparent protective film and a color filter were obtained in the same manner as in Example 1, with the exception that the thermosetting one-solution type composition for a protective film of a color filter J prepared in Comparative Preparative Example 1 was used, instead of the thermosetting one-solution type composition for a protective film of a color filter F.

<Assay of Physical Properties>

The glass substrates and the color filters obtained in Examples 1 to 4 and Comparative Example 1 were measured for flatness, coherence and film strength according to the following procedures. In addition, the thermosetting compositions obtained in Preparative Examples 1 to 4 and Comparative Preparative Example 1 were measured for storage stability. The results are summarized in Table 1, below.

1) Flatness

To assay flatness, the height difference between central portions of red pixels and green pixels of the dummy color filter (height difference between pixels) was determined. Then, the height difference between central portions of red pixels and green pixels of the color filter coated with the protective film of each of Examples 1 to 4 and Comparative Example 1 was determined. According to Equation 1, below, the ratio R of height difference d₁ between pixels of a color filter before being coated with the protective film and height difference d₂ between pixels of a color filter after being coated with the protective film was calculated. Flatness of the composition for a protective film of the present invention was assigned one of five grades from 1 to 5, depending on the following criteria.
R=d₂/d₁ Equation 1

‘1’ was assigned when R>0.4, ‘2’ when 0.4≦R≦0.3, ‘3’ when 0.3<R≦0.2, ‘4’ when 0.2<R≦0.1, and ‘5’ when R<0.1. As such, 1 shows low flatness, and 5 shows high flatness.

2) Coherence and Chemical Resistance Test

On the protective film of a color filter obtained in Examples 1 to 4 and Comparative Example 1, 100 crosscuts were formed in the check shapes. Then, a peeling test (crosscut test) was performed using a cellophane tape, after which the number of remaining crosscuts was counted, to assay coherence of the protective film.

Further, the protective film was dipped into each of N-methyl-2-pyrrolidone (NMP), a 10% aqueous potassium hydroxide solution, and an etchant (LCE-12K, CYANTEK CORPORATION) at 40° C. for 30 min. Thereafter, the peeling test was performed in the same manner as in the above coherence test. ‘Good’ was assigned when the number of remaining crosscuts was 100, whereas ‘bad’ was assigned when the number of crosscuts was less than 100, to assay the chemical resistance of each solution.

3) Film Strength

The transparent protective film obtained in each of Examples 1 to 4 and Comparative Example 1 was scratched using six kinds (1H-6H) of pencils available from Staedtler. The film strength was assigned a score from 1H to 6H depending on the degree of damage to the substrate.

4) Storage Stability

The thermosetting composition obtained in each of Preparative Examples 1 to 4 and Comparative Preparative Example 1 was measured for initial viscosity, after which it was loaded into a 10 ml vial and then stored using an incubator at 40° C. The viscosity was measured every 3 days. After 12 days, as a result of measuring the viscosity 5 times, an increase in a viscosity exceeding 10% was represented by 0, 3, 6, 9, or 12. As such, 3 or less is judged to ‘bad’.

TABLE 1

| | | Coherence | Chemical Resistance | | | |
|---|---|---|---|---|---|---|
| | | (Before/After | (NMP/10% aq.POH/ | | | Storage |
| Sample | Flat. | Peeling) | Etchant) | Transmit. | Film Strength | Stability |
| H | 2 | 100/100 | Good/Good/Good | 99 | 3H | 6 |
| I | 3 | 100/100 | Good/Good/Good | 98 | 4H | 9 |
| J | 3 | 100/100 | Good/Good/Good | 99 | 5H | 9 |
| K | 4 | 100/100 | Good/Good/Good | 98 | 4H | 6 |
| L | 5 | 100/100 | Good/Good/Good | 98 | 5H | 9 |
| M | 4 | 100/100 | Good/Good/Good | 99 | 5H | 12 |
| N | 2 | 100/100 | Good/Good/Good | 98 | 4H | 3 (Bad) |

As is apparent from Table 1, the protective film for a color filter manufactured using the thermosetting one-solution type composition for a protective film of the present invention has excellent flatness, coherence, chemical resistance, transmittance, and film strength. Further, the composition of the present invention has higher storage stability than a conventional thermosetting composition for a color filter.

As described hereinbefore, the present invention provides a thermosetting one-solution type composition for a protective film of a color filter and a color filter using the same. The thermosetting one-solution type composition for a protective film of the present invention can be stored for a longer time than a conventional thermosetting composition for a color filter. Further, the protective film of a color filter manufactured using the thermosetting one-solution type composition for a protective film of the present invention exhibits excellent flatness, chemical resistance, coherence, transmittance, and film strength.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A thermosetting one-solution type composition for a protective film of a color filter, comprising:
(i) a self-curing copolymer, which includes at least one selected from among constituent units represented by Formulas 1 and 2, below, and a constituent unit represented by Formula 3, below; and
(ii) an organic solvent: 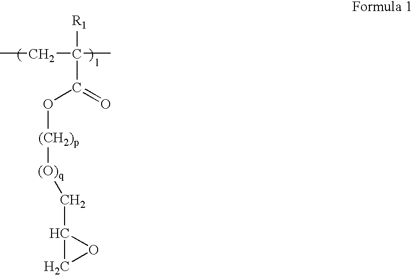
Wherein each R₁ is independently a hydrogen atom or a methyl group, l is 20-85 mol %, p is an integer of 0 or from 2 to 9, and q is 0 when p is 0, or 1 when p is 2 to 9; 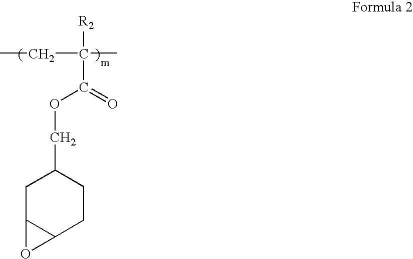
Wherein each R₂ is independently a hydrogen atom or a methyl group, and m is 20-85 mol %; and 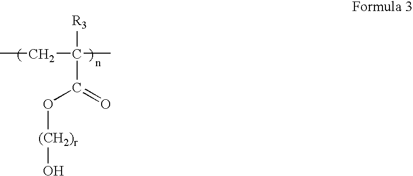
Wherein each R₃ is independently a hydrogen atom or a methyl group, n is 5-45 mol %, and r is an integer from 2 to 9.

2. The composition as set forth in claim 1, wherein the self-curing copolymer further comprises a constituent unit represented by Formula 4, below: 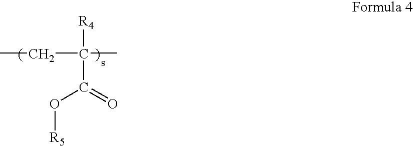
Wherein each R₄ is independently a hydrogen atom or a methyl group, s is 10-30 mol %, and each R₅ is independently any one selected from among compounds represented by Formula 5, below: 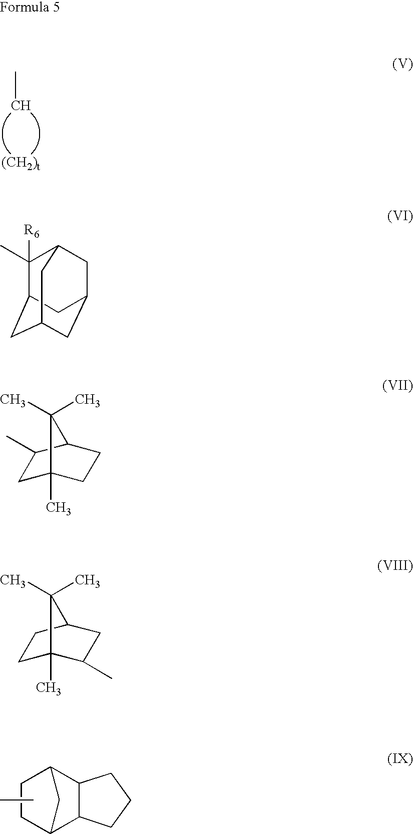
Wherein t is an integer from 4 to 12, and R₆ is a hydrogen atom or a methyl group.

3. The composition as set forth in claim 1 or 2, wherein the l+m ranges from 20 to 85 mol %.

4. The composition as set forth in claim 1 or 2, wherein the self-curing copolymer has a weight average molecular weight ranging from 3,000 to 1,000,000.

5. The composition as set forth in claim 1 or 2, further comprising at least one polymer selected from polymers comprising epoxy resins including bisphenol-A epoxy, bisphenol-F epoxy, phenol novolac type epoxy, cresol novolac type epoxy or substituted epoxy, poly(meth)acrylate, nylon, polyester, polyimide, and a silicon polymer.

6. The composition as set forth in claim 1 or 2, wherein the self-curing copolymer further comprises at least one material selected from the group consisting of unsaturated organic acids including (meth)acrylic acid or maleic acid and anhydrides thereof, (meth)acrylates including methyl (meth)acrylate, ethyl (meth)acrylate, propyl(meth)acrylate, isopropyl(meth)acrylate, butyl(meth)acrylate, benzyl(meth)acrylate or hydroxypropyl(meth)acrylate, acrylamides including N-methylacrylamide, N-ethylacrylamide, N-isopropylacrylamide, N-methylolacrylamide, N-methylmethacrylamide, N-ethylmethacrylamide, N-isopropylmethacrylamide, N-methylolmethacrylamide, N,N-dimethylacrylamide, N,N-diethylacrylamide, N,N-dimethylmethacrylamide or N,N-diethylmethacrylamide, styrenes including styrene, α-methylstyrene or hydroxystyrene, N-vinylpyrrolidone, N-vinylformamide, N-vinylamide, and N-vinylimidazole.

7. The composition as set forth in claim 1 or 2, wherein the organic solvent comprises at least one material selected from among ethyleneglycols including ethyleneglycol or diethyleneglycol, glycolethers including ethyleneglycolmonomethylether, diethyleneglycolmonomethylether, ethyleneglycoldiethylether or diethyleneglycoldimethylether, glycoletheracetates including ethyleneglycolmonoethyletheracetate, diethyleneglycolmonoethyletheracetate or diethyleneglycolmonobutyletheracetate, propyleneglycols, propyleneglycolethers including propyleneglycolmonomethylether, propyleneglycolmonoethylether, propyleneglycolmonopropylether, propyleneglycolmonobutylether, propyleneglycoldimethylether, dipropyleneglycoldimethylether, propyleneglycoldiethylether or dipropyleneglycoldiethylether, propyleneglycoletheracetates including propyleneglycolmonomethyletheracetate or dipropyleneglycolmonoethyletheracetate, amides including N-methylpyrrolidone, dimethylformamide or dimethylacetamide, ketones including methylethylketone (MEK), methylisobutylketone (MIBK) or cyclohexanone, petroleum including toluene, xylene or solvent naphtha, esters including ethylacetate, butylacetate or ethyloleate, and combinations thereof.

8. A color filter, comprising a protective film manufactured using the thermosetting one-solution type composition for a protective film of a color filter of claim 1 or 2.

9. A liquid crystal display, comprising the color filter of claim 8.
